(19) United States
(12) Patent Application Publication
(10) Pub. No.: US 2018/0279004 A1
(43) Pub. Date: Sep. 27, 2018

(54) INFORMATION PROCESSING APPARATUS, INFORMATION PROCESSING METHOD, AND PROGRAM

(71) Applicant: SONY CORPORATION, Tokyo (JP)

(72) Inventors: Kei TAKAHASHI, Tokyo (JP); Masashi TAKEDA, Tokyo (JP); Shigefumi TAMURA, Tokyo (JP)

(73) Assignee: SONY CORPORATION, Tokyo (JP)

(21) Appl. No.: 15/916,695

(22) Filed: Mar. 9, 2018

(30) Foreign Application Priority Data
Mar. 24, 2017 (JP) 2017-059510

(51) Int. Cl. H04N 21/466; G06Q 30/02; H04N 21/454; H04N 21/234

(52) U.S. Cl. CPC H04N 21/4668; H04N 21/23424; H04N 21/454; G06Q 30/0269

(57) ABSTRACT

There is provided an information processing apparatus including: a data processing unit configured to decide recommended content on a basis of a user profile of a content-viewing user, and position information of a content-providing apparatus operated by at least one content-providing user different from the content-viewing user. The data processing unit transmits the decided recommended content to a content-outputting apparatus of the content-viewing user, and transmits product information about a product associated with displayed content on the content-outputting apparatus to the content-outputting apparatus.

### CROSS REFERENCE TO RELATED APPLICATIONS

This application claims the benefit of Japanese Priority Patent Application JP 2017-059510 filed Mar. 24, 2017, the entire contents of which are incorporated herein by reference.

### BACKGROUND

The present disclosure relates to an information processing apparatus, an information processing method, and a program. More particularly, the present disclosure relates to an information processing apparatus, an information processing method, and a program making it possible to apply a profile of a viewing user of network-delivered content to select recommended content, present the selected recommended content, and purchase products related to the presented content.

Recently, the delivery and viewing of content over networks such as the Internet is flourishing. There is a vast amount of content on the net, and a viewing user must select which content one wants to watch from among this vast amount of content.

Also, recently, an increasing number of services provide free viewpoint video in which the viewpoint direction is changeable, such as multi-viewpoint video captured with a multi-viewpoint camera including multiple cameras, omnidirectional video captured with an omnidirectional camera, or panoramic video, for example.

For example, a head-mounted display used by being worn on the head can be used to view free viewpoint video. For example, a proposal has been made regarding a head-mounted display system provided with a capturing subsystem that captures a wide-angle image of wider angle than a display image which is actually displayed, and on the basis of position information regarding the user's head detected by a rotational angle sensor, the display image that the user should see is cut out and displayed (for example, see JP H8-191419A).

Also, by applying bidirectional communication to a free viewpoint video delivery service, an interactive viewing service can be realized. For example, video in which the viewpoint position and viewpoint direction has been switched for each user can be delivered, and a variety of needs can be met (for example, see JP 2013-255210A).

Free viewpoint video can be utilized as content related to entertainment such as sports, games, concerts, and drama, for example. Also, through bidirectional communication between the capturing site and the viewer, it is also possible to provide instruction, teaching, guidance, and assistance to the videographer, who captures a still/moving image, from the viewer of the content.

There is a vast amount of content on the net, including such free viewpoint video content, and for example, an image-providing user may be notified of a request from a viewing user who observes an image transmitted over a network, thereby enabling the user on the image-providing side to carry out various specific actions and requests.

### SUMMARY

It is desirable, for example, to provide an information processing apparatus, an information processing method, and a program making it possible to apply a profile of a viewing user of network-delivered content to select recommended content, present the selected recommended content, and purchase products related to the presented content.

According to a first embodiment of the present disclosure, there is provided an information processing apparatus including: a data processing unit configured to decide recommended content on a basis of a user profile of a content-viewing user, and position information of a content-providing apparatus operated by at least one content-providing user different from the content-viewing user. The data processing unit transmits the decided recommended content to a content-outputting apparatus of the content-viewing user, and transmits product information about a product associated with displayed content on the content-outputting apparatus to the content-outputting apparatus.

According to a second embodiment of the present disclosure, there is provided an information processing method using an information processing apparatus, the information processing method including: controlling an information processing apparatus to decide recommended content on a basis of a user profile of a content-viewing user, and position information of a content-providing apparatus operated by at least one content-providing user different from the content-viewing user; controlling the information processing apparatus to transmit the decided recommended content to a content-outputting apparatus of the content-viewing user; and controlling the information processing apparatus to transmit product information about a product associated with displayed content on the content-outputting apparatus to the content-outputting apparatus.

According to a third embodiment of the present disclosure, there is provided a program causing information processing to be executed in an information processing apparatus, the program including: an instruction of controlling the information processing apparatus to decide recommended content on a basis of a user profile of a content-viewing user, and position information of a content-providing apparatus operated by at least one content-providing user different from the content-viewing user; an instruction of controlling the information processing apparatus to transmit the decided recommended content to a content-outputting apparatus of the content-viewing user; and an instruction of controlling the information processing apparatus to transmit product information about a product associated with displayed content on the content-outputting apparatus to the content-outputting apparatus.

Note that a program according to an embodiment of the present disclosure is, for example, a program provided in computer-readable format to an information processing apparatus or a computer system capable of executing various program code, the program being providable by a storage medium or communication medium. By providing such a program in a computer-readable format, processing corresponding to the program is realized on the information processing apparatus or the computer system.

Further objectives, features, and advantages of the present disclosure will be clarified by a more detailed description based on the embodiments of the present disclosure described hereinafter and the attached drawings. Note that in this specification, the term “system” refers to a logical aggregate configuration of multiple devices, and the respective devices of the configuration are not limited to being inside the same housing.

According to the configuration of an embodiment of the present disclosure, there is realized a configuration making it possible to select recommended content based on the profile of a content-viewing user, and also present and purchase products related to the presented content. Specifically, for example, on the basis of a user profile of the content-viewing user, products that the content-viewing user is interested in are estimated, content that includes a video of stores selling the estimated products is decided as recommended content, and the decided recommended content is transmitted to a content-outputting apparatus on the content-viewing user side. Furthermore, a product list and a product purchase list are presented together with the content, enabling the content-viewing user to make product purchases utilizing the product purchase list. According to this configuration, there is realized a configuration making it possible to select recommended content based on the profile of a content-viewing user, and also present and purchase products related to the presented content. Note that the advantageous effects described in this specification are merely for the sake of example and non-limiting, and there may be additional advantageous effects.

### BRIEF DESCRIPTION OF THE DRAWINGS

FIG. 1 is a diagram illustrating an exemplary configuration of an information processing system 100;

FIG. 2 is a diagram illustrating an exemplary configuration of a content-providing apparatus 101;

FIG. 3 is a diagram illustrating an exemplary configuration of a content-outputting apparatus 104;

FIG. 4 is a diagram illustrating an example of user profile information;

FIG. 5 is a diagram illustrating an example of display information displayed on the content-outputting apparatus side;

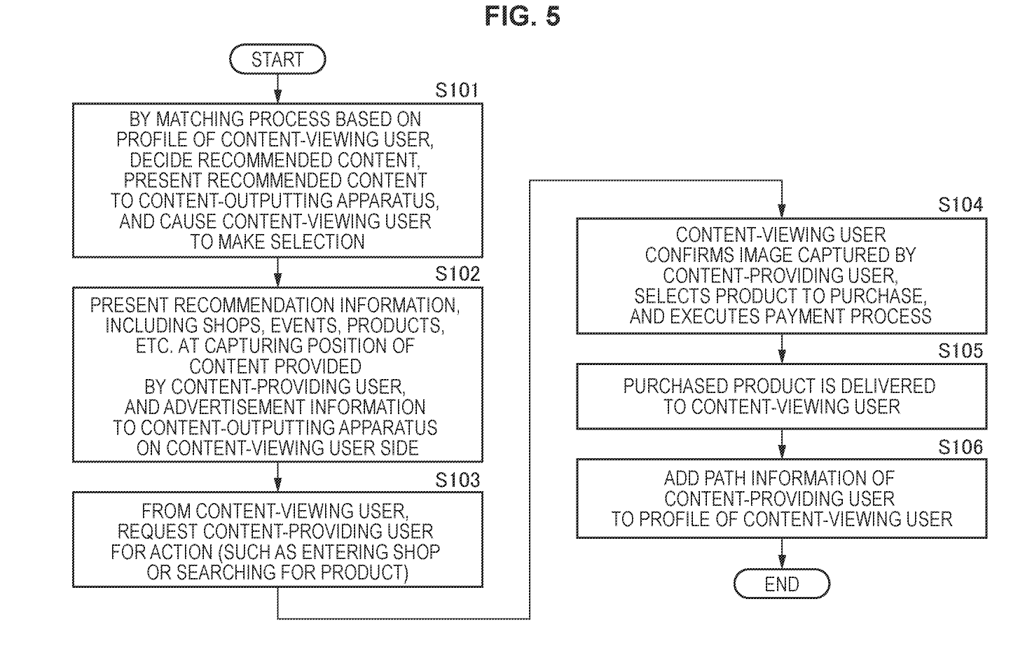

FIG. 6 is a diagram illustrating an example display information displayed on the content-outputting apparatus side;

FIG. 7 is a diagram illustrating a flowchart explaining an information processing sequence; and

FIG. 8 is a diagram explaining an exemplary hardware configuration of an information processing apparatus.

### DETAILED DESCRIPTION OF THE EMBODIMENT(S)

Hereinafter, the details of an information processing apparatus, an information processing method, and a program of an embodiment of the present disclosure will be described with reference to the drawings. Note that the following items will be described.

1. Exemplary configuration of information processing system

2. Exemplary configuration of content-providing apparatus and content-outputting apparatus

3. User profile information

4. Specific example of content recommendation process

5. Processing sequence executed by information processing apparatus according to embodiment of present disclosure

6. Exemplary hardware configuration of information processing apparatus

7. Summary of configuration according to embodiment of present disclosure

### [1. Exemplary Configuration of Information Processing System]

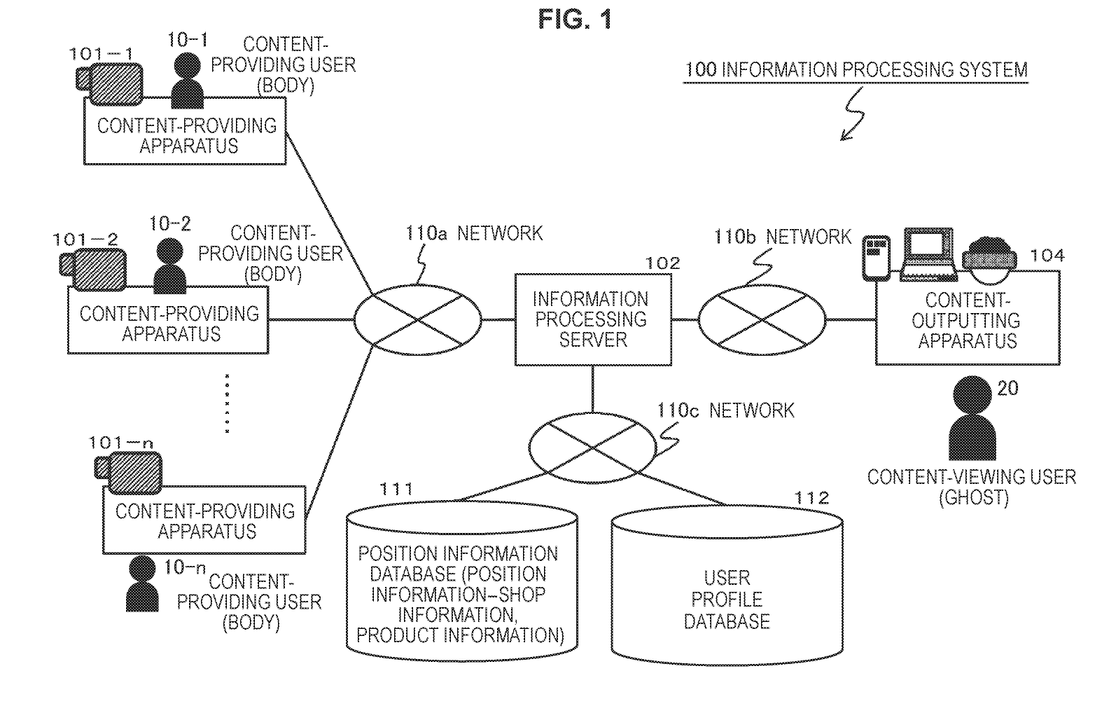

FIG. 1 is a diagram illustrating an exemplary configuration of the information processing system 100 utilizing an information processing apparatus according to an embodiment of the present disclosure.

Specifically, for example, the information processing system 100 is configured as a free viewpoint video delivery system.

Captured image information, such as free viewpoint video acquired using content-providing apparatus 101-1 to 101-n (for example, imaging apparatus such as multi-viewpoint cameras or omnidirectional cameras), is transmitted to an information processing server 102 over a network 110a. As illustrating in FIG. 1, the numerous content-providing apparatus 101-1 to 101-n which act as the suppliers of captured image information exist in large numbers at various positions.

It is sufficient for the content-providing apparatus 101-1 to 101-n to be able to acquire captured image information in a space where, for example, content videographers who use imaging apparatus, namely content-providing users (Bodies) 10-1 to 10-n, exist. Any of various types of apparatus configurations may be adopted for the content-providing apparatus 101-1 to 101-n.

For example, in addition to typical camera apparatus, multi-viewpoint cameras, and omnidirectional cameras, the content-providing apparatus 101 may also take the form of a wearable device worn by a videographer, like a head-mounted display provided with an imaging section such as a camera or an imager.

Note that a user who performs a content acquisition process using a content-providing apparatus 101 is called a content-providing user (Body) 10. Meanwhile, a user who views content acquired by a content-providing user (Body) is called a content-viewing user (Ghost) 20.

A videographer who acts as a content-providing user 10 is called a Body because that person is engaged in activity with one's own body at the actual site of capturing (that is, one's body is physical present at the site). Note that a videographer is anticipated to be not only a person (natural person), but also mobile apparatus such as vehicles (including vehicles driven manually by a person as well as vehicles which drive automatically or which are unmanned), boats, aircraft, robots, and drones.

On the other hand, a user who is not actually present at the site of capturing, and who views content displayed through the screen of a smartphone. PC, or the like is called a Ghost. The content-viewing user (Ghost) 20 is not engaged in activity with one's own body at the site, but is able to have consciousness of the site by viewing video seen from the viewpoint of a content-providing user, namely a videographer. In this way, a content-viewing user is called a Ghost because only that person's consciousness is present at the site. The terms Body and Ghost are terms for distinguishing each user.

Note that the space where the content-providing user (Body) 10 exists is basically a real space, but can also be defined as a virtual space instead of a real space. Hereinafter, “real space” or “virtual space” will be simply designated “space” in some cases. Also, captured image information acquired by the content-providing apparatus 101 can also be called content information associated with the space of the content-providing user 10. Hereinafter, captured image information acquired by the content-providing apparatus 101 is also called “content”.

The present embodiment anticipates that numerous videographers acting as content-providing users 10 each go to a point of interest (POI; a place someone thinks is convenient or interesting), and perform capturing work there using each of the content-providing apparatus 101. Also, in some cases, multiple videographers are present at a single POI at the same time, and multiple pieces of content acquired at multiple viewpoint positions at the same POI are transmitted to the information processing server 101 in such cases, on the viewer side described later, even at the same POI, it becomes possible to select one from among multiple viewpoint positions, and view free viewpoint video at the viewpoint position.

Examples of a POI referred to herein may include a tourist attraction, a commercial facility or each shop inside a commercial facility, a stadium where a. sports competition such as baseball or soccer takes place, a hall, a concert venue, a theater, and the like. However, the capturing location is not limited to a POI or the like.

The information processing server 102 seams content in real-time (live video) transmitted from each content-providing apparatus 101 to each viewer of free viewpoint video over a network 110b. Note that even if the network 110b is a part of a wide-area network together with the network 110a, the network 110b may also be a network independent from the network 110a.

The content-viewing user (Ghost) 20 views content acquired by the content-providing apparatus 101 via the content-outputting apparatus 104. The content-outputting apparatus 104 is configured by a device such as a PC, a smartphone, or a head-mounted-display, for example, by a combination of a PC and a head-mounted display, for example, or the like. The content-outputting apparatus 104 is an apparatus enabling the viewing of virtual reality (VR) video, for example.

For example, the content-outputting apparatus 104 such as a head-mounted display includes an on-board stereo camera and 9 degrees of freedom (9 DoF) sensor or the like, and is capable of localization. Also, the content-outputting apparatus 104 such as a head-mounted display is assumed to be able to detect the gaze of the viewer, namely the content-viewing user, by using a pupil-corneal reflection method or the like, and from the rotational center positions of the left and right eyes and the facing of the visual axis (as well as the head attitude), compute the gaze direction of the content-viewing user. Alternatively, the forward direction may simply be treated as the gaze direction of the content-viewing user, on the basis of measurement by head tracking or the estimated attitude of the head.

For example, in the case in which the content-outputting apparatus 104 is configured by a PC and a head-mounted display, the head-mounted display acquires a self-position and a gaze direction, and transmits the acquired information successively to the PC. The PC receives a content stream of free viewpoint video from the information processing server 102 over the network 110b. Additionally, the PC renders free viewpoint video with the self-position received from the head-mounted display and a prescribed field of view (FoV). Subsequently, the rendering result is displayed on the display of the head-mounted display. The viewer, by changing the attitude of one's own head, is able to freely control the viewpoint position and the gaze direction.

Note that a configuration can also be taken in which the process of rendering free viewpoint video based on the self-position and the gaze direction of the viewer is performed inside the head-mounted display rather than on the PC. Also, a configuration can be taken in which the head-mounted display connects directly to the network 110b, without going through the PC. Alternatively, instead of using a head-mounted display, rendered free viewpoint video may be displayed on a monitor or display provided with respect to the PC or a smartphone, and viewed by the viewer.

Furthermore, on the screen of the content-outputting apparatus 104, for example, a user interface (UI) including recommendation information including a list of content captured by the numerous content-providing apparatus 101-1 101-n or the like may be displayed, and the content-viewing user 20 may select content through an operation on the UI screen. A variety of layouts are possible as the screen layout of the UI that displays the recommendation information. For example, the layout may be a list of titles or thumbnails of representative images of the content, a display of the capturing locations of the free viewpoint video (the locations where the content-providing apparatus 101 are installed, or the locations where the content-providing users are present), or a list of user names (including nicknames or handle names) or thumbnails of face images of the videographers, namely the content-providing users.

In this specification, the framework of interaction when the content-viewing user 20 views content acquired on the content-providing user 10 side is also called “JackIn (connection)”. The content-viewing user 20 is able to view content associated with the space of the connected content-providing user 10. When connected to the content-viewing user 20, the content-providing user can also be said to deliver content associated with one's own space.

Users connect to each other for a variety of objectives. For example, besides the objective of simply viewing content associated with a space where oneself is not present or content one is interested in (for example, watching sports captured on the content-providing user 10 side), in some cases, the content-viewing user 20 may connect to the content-providing user 10 with the objective of providing teaching or assistance to the content-providing user 10.

Specifically, for example, it is possible for the content-viewing user (Ghost) 20 to request the content-providing user (Body) 10 to enter a certain shop in a space where the content-providing user (Body) 10 is present, and capture products.

Note that in the following, as one specific embodiment, an embodiment will be described in which a profile of the content-viewing user (Ghost) 20 is applied to select recommended content, present the selected recommended content, and purchase products related to the presented content.

In the information processing system 100 illustrated in FIG. 1, a position information database 111 and a user profile database 112 are connected over a network 110c. Note that even if the network 110c is a part of a wide-area network together with the networks 110a and 110b, the network 110c may also be a network independent from the networks 110a and 110b.

The position information database 111 is a database storing correspondence data between the position information of shops, and shop information (such as the type of shop and hours of operation) other than the position information of the shops and product information. The information processing server 102 is able to acquire shops near the positions of the content-providing apparatus 101-1 to 101-n and product information about products in the shops from the position information database 111, and display the acquired information on the content-outputting apparatus 104.

In the user profile database 112, information related to the content-viewing users 20 on the content-outputting apparatus 104 side is stored. For example, the above information includes user demographic information, user preference information, history information related to the actions, states, and the like of the content-viewing users, biological information about the content-viewing users detected while content is being viewed, companion information about companions who view content together with the content-viewing users, environmental information about the environment where the free viewpoint video is being viewed, and the like. These pieces of user information are called a “user profile”.

The information processing server 102, on the basis of the profile of a content-viewing user 20 stored in the user profile database 112, for example, is able to select products for which the content-viewing user 20 has a high purchase intention, or shops that the content-viewing user 20 is likely to be interested in. Furthermore, the position information of shops of high interest or shops selling products of high interest can be acquired from the position information database 111. Additionally, a content-providing user 10-x present near the position is specified, and a process of presenting the captured content of the content-providing apparatus 101-x of the content-providing user 10-x as recommended content to the content-viewing user 20 is performed.

In the present embodiment, the information processing server 102, by performing a matching process based on the profile of the content-viewing user 20 stored in the user profile database 112, for example, selects candidates of the content-providing user 10 to connect with or the captured content of the content-providing user 10 as recommendation information for the content-viewing user 20.

Note that such a recommendation process is executable on the information processing server 102, but may also be configured to be executed on an external server not illustrated in FIG. 1. When candidates of the content-providing user 10 to recommend for connection with the content-viewing user 20 (or candidates of the content to recommend for viewing) are obtained by the matching process results, recommendation information including information about the candidates is presented on the UI screen of the content-outputting apparatus 104.

The content-outputting apparatus 104 transmits, to the information processing server 102 over the network 110b, a request to access the content-providing user 10, or the content provided by the content-providing user 10, that has been selected by the content-viewing user 20 with an operation on the UI screen. Alternatively, the content-outputting apparatus 104 may also transmit an access request directly to the corresponding content-providing apparatus 101.

### [2. Exemplary Configuration of Content-providing Apparatus and Content-outputting Apparatus]

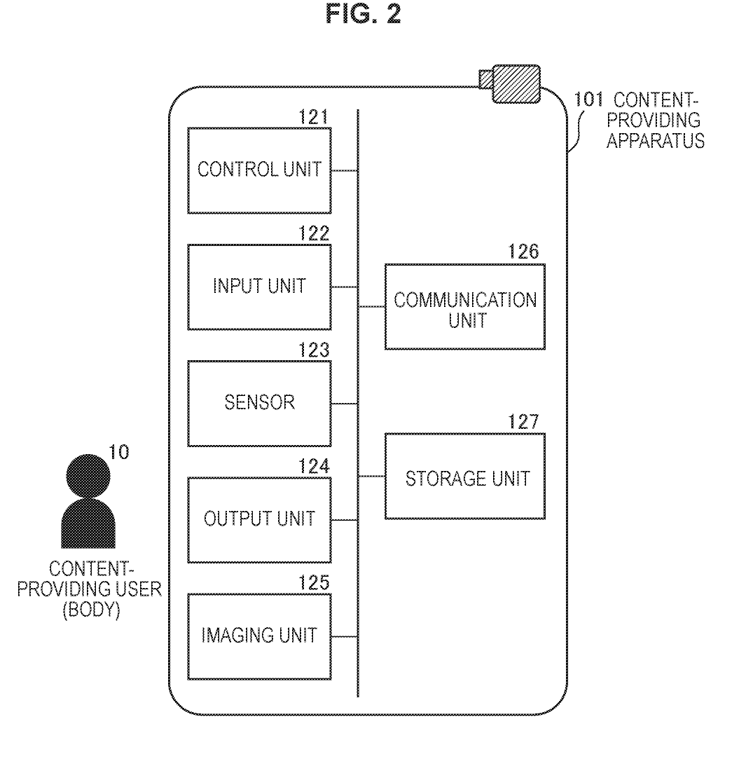

Next, an exemplary configuration of the content-providing apparatus 101 and the content-outputting apparatus 104 will be described with reference to FIG. 2 and the subsequent drawings.

FIG. 2 illustrates an exemplary configuration of the content-providing apparatus 101. The content-providing apparatus 101 includes a control unit 121, an input unit 122, a sensor 123, an output unit 124, an imaging unit 125, a communication unit 126, and a storage unit 127.

The control unit 121 controls various processes executed in the content-providing apparatus 101. For example, control is executed in accordance with a program stored in the storage unit 127. The input unit 122 includes the input of operation information by the user, an audio input unit (microphone) that inputs audio information, and the like. The audio input unit may be either a monaural microphone or a stereo microphone, and picks up the voice of the content-providing user during capturing, sounds produced by the subject being captured with the content-providing apparatus 101, and the like.

The sensor 123 is a sensor that detects the conditions around the content-providing user, and includes various types of environment sensors that detect information related to the weather of the space where the content-providing user 10 is present (or during capturing), such as the temperature, humidity, atmospheric pressure, and luminous intensity. In addition, the sensor 123 may also include biological sensors that detect biological information about the videographer, such as body temperature, pulse, perspiration, respiration, and brain waves. Furthermore, the sensor 123 may also be provided with an imaging apparatus other than the content-providing apparatus 101 that captures the videographer, namely the content-providing user oneself and companions of the videographer, and acquires information about the user oneself or information about the companions through processes such as face detection and face recognition.

Additionally, the sensor 123 may also include a position sensor that measures the current position of the content-providing apparatus 101 or the content-providing user 10. The position sensor, for example, receives Global Navigation Satellite System (GNSS) signals from GNSS satellites (for example, Global Positioning System (GPS) signals from GPS satellites) to execute positioning, and generates position information including the latitude, longitude, and altitude of a vehicle. Alternatively, the position sensor may specify the current position on the basis of signal strength information from wireless access points by utilizing PlaceEngine (registered trademark).

The information detected by the sensor 123 can be treated as information associated with the space of the content-providing user 10, and can also be treated as information associated with an acquisition period of content.

In the space where the content-providing apparatus 101 or the content-providing user 10 is present, there is provided an output unit 124 capable of presenting information to the videographer, namely the content-providing user 10, via video display, audio output, and the like. On a display screen provided in the output unit 124, a UI including recommendation information containing a list of content delivery destinations (content-viewing users requesting access to the content) or the like may be displayed, and the content-providing user 10 may select a content delivery destination through an operation on the UI screen.

In addition, besides video and audio output, the output unit 124 may also be provided with a configuration for producing output such as vibration, mild electric shock, or haptic (tactile) feedback. Furthermore, the output unit 124 may also include a device capable of supporting or restricting at least part of the limbs of the content-providing user 10, and instructing the content-providing user 10 about actions to perform, like an exoskeleton device. The output unit 124 can be utilized to provide information feedback from a viewer of content, namely the content-viewing user side, and to provide instruction and assistance from the content-viewing user 20 to the content-providing user 10.

The imaging unit 125 is an imaging unit that takes images. The communication unit 126 is connected to the network 110a, and transmits AV content, which includes the content acquired by the content-providing apparatus 101 and audio during imaging picked up by the input unit 122, and also receives information to be output by the output unit 124. Additionally, the communication unit 126 may also transmit environmental information or the like measured by the sensor 123. Also, the communication unit 126 is able to receive an access request with respect to content (or a connection request) from the content-viewing user 20, either directly, or indirectly via the information processing server 102.

The storage unit 127 is utilized as a storage area for the programs of processes executed in the control unit 121 and the like, captured images, and the like, for example. Furthermore, the storage unit 127 is also utilized as a work area or the like for parameters used in various processing, and for a variety of processes.

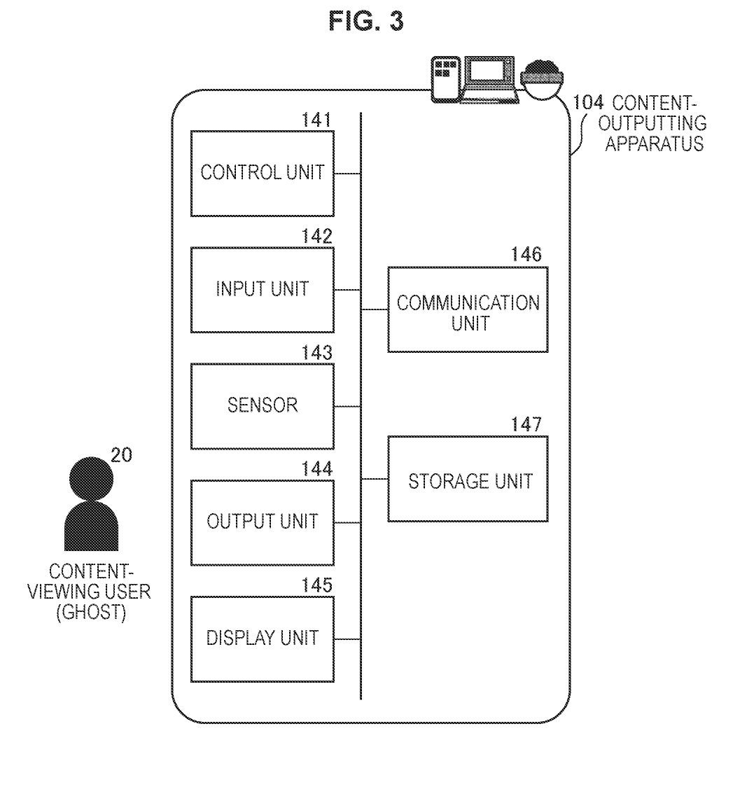

FIG. 3 illustrates an exemplary configuration of the content-outputting apparatus 104. Basically, the content-outputting apparatus 104 is used for the display of content acquired on the content-providing user 10 side as a videographer (or for viewing by the content-viewing user 20). The content-outputting apparatus 104 is provided with a UI function in addition to a content display function, and is assumed to be capable of displaying information related to the content recommended by the information processing server 102 and enabling a content selection operation by the content-viewing user 20, for example.

As illustrated in FIG. 3, the content-outputting apparatus 104 includes a control unit 141, an input unit 142, a sensor 143, an output unit 144, a display unit 145, a communication unit 146, and a storage unit 147. The control unit 141 controls processes executed in the content-outputting apparatus 104. For example, control is executed in accordance with a program stored in the storage unit 147.

The input unit 142 includes various devices, such as audio input unit (microphone) for inputting audio information, a camera that captures the content-viewing user and one's companions, an input device such as a keyboard, and a coordinate input device such as a mouse or a touch panel. For example, speech, textual information, coordinate information, and the like produced by the content-viewing user and one's companions while viewing free viewpoint video is acquired via the input unit 142.

Note that the input unit 142 may also include input devices of a type used by being worn on the body of a viewer, like gloves or clothing, such as a type enabling the movements of the fingertips and torso to be input directly, for example. The content-viewing user 20 viewing content in real-time is able to use the input unit 142 to input instructions (such as assistance) with respect to the videographer of the content, namely the content-providing user 10. When at least part of the input information acquired by the input unit 142 is transmitted to the content-providing apparatus 101 side, in the space of the content-providing user 10, instructions from the content-viewing user 20 are output by the output unit 124.

Also, in the space where the content-outputting apparatus 104 or the content-viewing user 20 is present, there is provided a sensor 143 that detects the conditions around the content-viewing user 20 for whom the viewing environment or the like changes dynamically. The sensor 143 includes various types of environment sensors that detect information related to the weather of the space where the content-viewing user 20 is present (or during content viewing), such as the temperature, humidity, atmospheric pressure, and luminous intensity. In addition, the sensor 143 may also include biological sensors that detect biological information about the viewer, such as body temperature, pulse, perspiration, respiration, and brain waves. Furthermore, the sensor 143 may be provided with an imaging apparatus that captures the viewer, namely the content-viewing user 20 oneself and one's companions, and may be configured to acquire information about the user oneself and the companions by performing processes such as face detection and face recognition on the captured image.

Additionally, the sensor 143 may also include a position sensor that measures the current position of the content-outputting apparatus 104 or the content-viewing user 20, The position sensor, for example, receives GNSS signals from GNSS satellites to execute positioning, and generates position information including the latitude, longitude, and altitude of a vehicle. Alternatively, the position sensor may specify the current position on the basis of signal strength information from wireless access points by utilizing PlaceEngine (registered trademark).

The information detected by the sensor 143 can be treated as information associated with the space of the content-viewing user 20. Additionally, during the period in which received content is being displayed by the content-outputting apparatus 104, or during the period in which the content-viewing user 20 is viewing the content, sensor information detected by the sensor 143 can also be treated as information associated with a viewing period of content.

Additionally, in the space where the content-outputting apparatus 104 or the content-viewing user 20 is present, an output unit 144 is provided. The output unit 144 performs a process of outputting audio and the like. For example, besides audio, the output unit 144 preferably takes a configuration that outputs environmental information for creating a variety of viewing environments. For example, the output unit 144 is a section of controlling the environment of the space of the content-viewing user 20 (or a multi-modal interface) that adjusts the temperature and humidity, blows wind (a breeze, a head wind, or an air blast) and sprays water (a water blast) onto the viewer, applies tactile feedback (such as an effect of poking the viewer in the back, or a sensation as though something is touching the viewer's neck or feet) or vibration, imparts a mild electric shock, and emits an odor or fragrance.

The output unit 144 is driven on the basis of the environmental information measured by the sensor 123 on the content-providing apparatus 101 side, for example, giving the viewer a realistic and immersive experience like at the capturing location. Additionally, the output unit 144 may also be driven on the basis of a result of analyzing the content to be displayed by the content-outputting apparatus 104, and impart effects to the content-viewing user 20 viewing the content.

Also, the output unit 144 is assumed to be provided with an audio output device such as speakers, and to output an audio signal seamlessly with the video stream, such as audio of the subject picked up at the capturing site where the content is acquired (or the space of the content-providing user 10), and speech emitted by the content-providing user 10 during capturing, The audio output device may also include multi-channel speakers, and may be capable of sound localization.

The display unit 145 is utilized to display content, display a user interface (UI), and the like. The communication unit 146 transmits information over the network 110b. For example, the communication unit 146 is able to transmit an access request with respect to the content-providing user 10 or the content, either directly to the content-providing apparatus 101, or indirectly via the information processing server 102.

Also, the communication unit 146 is able to transmit input information input into the input unit 142 while the content-viewing user 20 is viewing video to the content-providing apparatus 101 side over the network 110b. Additionally, the communication unit 146 is able to receive output information over the network 110b, and output to the content-viewing user 20 from the output unit 144.

The storage unit 147 is utilized as a storage area for the programs of processes executed in the control unit 141 and the like, and parameters used in various processing, for example. The storage unit 147 furthermore is utilized as a work area or the like for a variety of processes.

The information related to the content-viewing user 20 on the content-outputting apparatus 104 side includes, for example, user demographic information, history information related to the actions, states, and the like of the content-viewing user 20, biological information about the content-viewing user 20 detected by the sensor 143 while content is being viewed, companion information about companions who view content together with the content-viewing user, and environmental information about the environment where the free viewpoint video is being viewed. These pieces of user information are called a “user profile”.

A user profile stored for each viewer or for each viewing is stored in internal memory (the storage unit 147) of the content-outputting apparatus 104. Alternatively, a user profile for each viewer or for each viewing is stored inside the user profile database 112 constructed over the network. A detailed example of a user profile will be described below.

### [3. User Profile Information]

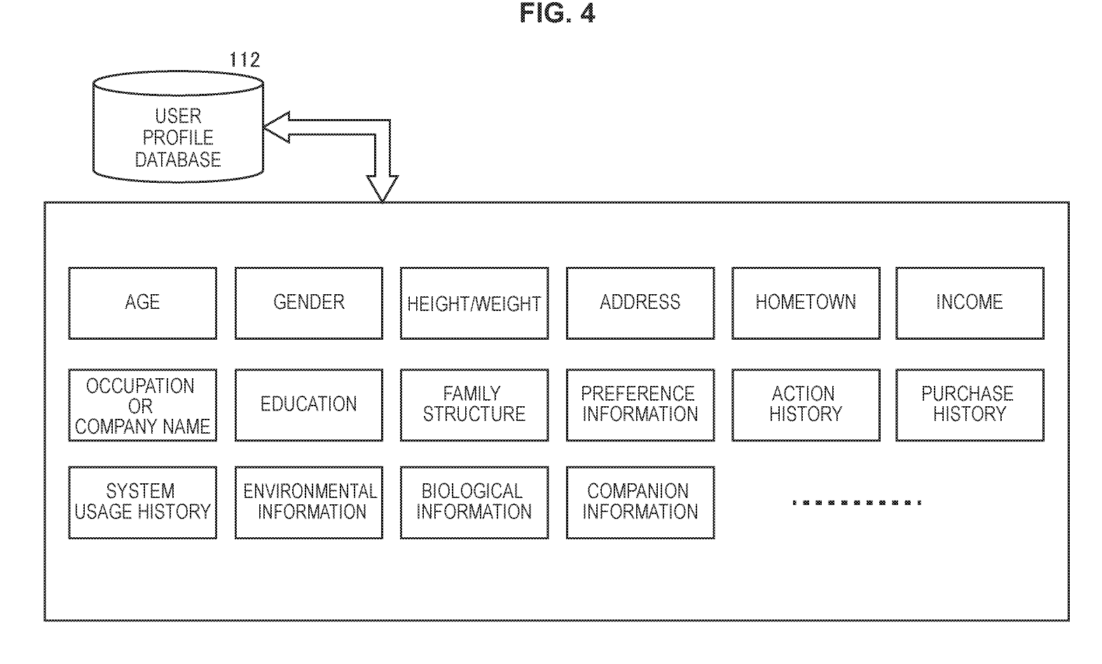

User information, that is, a user profile for each viewer or for each viewing is stored in the user profile database 112. FIG. 4 illustrates an example of information elements included in the user profile information stored in the user profile database 112. Each information element illustrated in FIG. 4 is data registered in association with a user ID, or a content-outputting apparatus ID.

The user profile information includes demographic information, which includes socioeconomic characteristic data such as an individual viewer's gender, age, height and weight, address (place of residence or place of work), birthplace, income, occupation, and also company name, education, and family structure. The demographic information typically includes information with fixed value, or static values that change slowly. Also, demographic information is known in the field of socioeconomics to have a strong linkage to consumer behavior, such as product purchasing and use, and is also utilized widely in the field of information technology.

In addition, the user profile information may also include history information related to the actions, states, and the like of videographer and the viewer, such as user preference information, an action history, a purchase history, a viewing history, a medical history, and a system usage history. An action history includes, for example, information such as places where the videographer or viewer has visited in the past, a movement path. and the like. Also, a viewing history is a viewing history of commercial content such as movies and television programs.

A system usage history includes a history of a user using the information processing system 100 in the past. Herein, the term “usage” includes both a history of a certain user acting as the content-providing user 10 and transmitting content such as free viewpoint video acquired by the content-providing apparatus 101 to the information processing server 102 or the content-viewing user 20, and also a history of a certain user acting as the content-viewing user 20 and issuing an access request to the content-providing user 10, and receiving/viewing content such as free viewpoint video.

A system usage history for the content-providing user 10 includes the capturing location or the location where content was acquired, the date and time, capturing parameters, a content transmission history, and the like. Also, a system usage history for the content-viewing user 20 is a history of accessed content, attribute information of content that has been viewed (such as information specifying the content name, the content storage location, and the content-providing user who captured the content), a content playback history (the playback segment, one's own position and gaze direction during playback, the displayed angle of view), and the like.

The profile information furthermore may include dynamic information that changes from moment to moment in the content-providing apparatus 101 or the videographer (that is, information associated with the acquisition period of the content information), such as environmental information measured by a sensor apparatus 202 around the content-providing apparatus 101, biological information about the content-providing user 10, companion information about companions accompanying the videographer during capturing, and the like. In the case of real-time content being transmitted from the content-providing apparatus 101, the information associated with the acquisition period of the content information changes from moment to moment in real-time.

In addition, the profile information may also dynamic information that changes from moment to moment in the content-outputting apparatus 104 or the viewer (that is, information associated with the viewing period of the content information such as environment information measured by the sensor 143 around the content-outputting apparatus 104, biological information about the viewer, companion information about companions accompanying the viewer during viewing, and the like.

Included among the demographic information is highly personally identifiable information, and personal information that is privacy-related even if not personally identifiable. Also, included among the history information and the dynamic information is privacy-related personal information, and information which is not necessarily privacy-related, but is still information that the videographer and the viewer would not want to be leaked to the outside. For this reason, the handling of profile information demands sufficient care.

### [4. Specific Example of Content Recommendation Process]

Next, a specific example of a content recommendation process executed by the information processing server 102, which is a structural element of the information processing system 100 illustrated in FIG. 1, will be described. The information processing server 102 provides recommended content information to the content-viewing user 20 on the content-outputting apparatus 104 side.

First, an overview of a matching process executed in a recommended content selection process by the information processing server 102 will be described. In the information processing system 100 illustrated in FIG. 1, the content-providing user 10 is the videographer of content such as free viewpoint video, for example, and the content-viewing user 20 is a user who uses the system 100 by viewing content. As illustrated in FIG. 1, numerous content-providing users 10 exist sporadically, and the content-viewing user 20 may need to select content to view from among the numerous content-providing users 10.

If the content-viewing user 20 is able to stumble across content one wants to see, one's desire to use the information processing system 100 again increases. On the other hand, for the content-providing user 10, if content that one has captured is viewed by numerous content-viewing users 20, or if content that one wants to be seen is viewed by the content-viewing user 20, one's desire to continue capturing activities and provide content in the future increases. Consequently, recommending appropriate content to the content-viewing user 20 to encourage viewing is extremely important for the further growth of the information processing system 100.

The information processing server 102 performs a recommended content selection process through a matching process. In the matching process, for example, attribute information, such as position information, for example, of the content of free viewpoint video captured by the content-providing apparatus 101, or shop information and product information associated with position information acquirable from the position information database 111 described above, and the user profile of the content-viewing user 20 described above can be used. In this specification, these pieces of position information are simply called position information related to the content-providing apparatus in some cases.

In the matching process, for example, a similarity calculation is performed between the user profile of the content-viewing user 20, for example the user preference information, and shops or products corresponding to the position of the content-providing user 10, and users or content with high-ranking similarity, or whose similarity exceeds a predetermined value, are extracted as recommendation candidates. Subsequently, recommendation information including information related to one or more candidates is presented to the user.

For example, information related to recommended content obtained by the matching process is presented as a UI screen to the content-viewing user 20 who views content. Herein, the term “recommended content” is real-time content currently being captured by the content-providing user 10. In other words, the content-providing apparatus 101 may be considered to generate “recommended content” by capturing a real space.

The format in which to present recommendation information to a content-viewing user may be a format that presents a candidate list of content, or a format that presents a candidate list of content-providing users acting as connection destinations. The candidate list is displayed on the UI screen. Additionally, the content-viewing user is able to select desired content to view or a connection destination with a UI operation.

Also, use cases in which the content-viewing user takes the initiative in performing the matching process (or for presenting recommendation information to the content-viewing user) include the two cases of selecting content-providing users or content matching the content-viewing user from among multiple content-providing users or content, and selecting an arbitrary content-providing user or another content-providing user related to content. The latter is a use case of, for example, selecting content related to content that the content-viewing user has viewed in the past, or another content-providing user (or content captured by a related content-providing user) related to the content-providing user who captured content that the content-viewing user has viewed in the past.

Also, as the method of realizing the matching process in each use case above, specifically the process of selecting (filtering) items (content or Bodies) to recommend to the content-viewing user, for example, the two methods of content-based filtering (CBF) and collaborative filtering (CF) can be used. Since each technique itself of CBF and CF is widely known in the relevant industries, a description of the details of these techniques is omitted.

CBF is a method of choosing information on the basis of the content of the information to recommend. For example, the content of the information can be compared to a user request to select information sought by the user. In the case of applying CBF in the information processing system 100, the content of the information corresponds to a content profile on the content-providing user side, the user request corresponds to the user profile on the content-viewing user side, and a content-providing user suited to the preferences of the content-viewing user (or content captured by such a content-providing user is chosen.

As an example of a CBF-like recommendation method, the similarity is calculated between the user profile of the content-viewing user and the content-providing user or the content profile of the content, and content-providing users or content with high-ranking similarity, or whose similarity exceeds a predetermined value, can be discovered as candidates close to the preferences of the content-viewing user. For example, with respect to a content-viewing user who frequently views tourism-related content, a content-providing user having a profile related to tourism, or content captured by such a content-providing user, can be recommended as a candidate.

As another example of a CBF-like recommendation method, by calculating the similarity of content profiles between content-providing users (or between content), another content-providing user (or content captured by that content-providing user) similar to an arbitrary content-providing user, or other content similar to arbitrary content, can be discovered as a candidate. For example, another content-providing user having a profile similar to a certain content-providing user that the content-viewing user has viewed in the past, or a content-providing user having a profile similar to a favorite content-providing user, can be recommended.

On the other hand, CF is a method of choosing information on the basis of user information, For example, information about other users with similar preferences can be used to select information sought by the user. In the case of applying CF in the information processing system 100, the user information corresponds to the user profile on the content-viewing user side, and on the basis of information about other content-viewing users similar to a certain content-viewing user, a content-providing user (or content captured by such a content-providing user) is chosen.

As an example of a CF-like recommendation method, the similarity of user profiles is calculated between content-viewing users, and a content-providing user who has captured content that another content-viewing user with close preferences has viewed in the past (or the content captured by such a content-providing user) can be discovered as a candidate. For example, suppose that a viewer A has viewed content captured by each of videographers 1, 2, 3, and 4, while a viewer B has viewed content captured by each of videographers 1, 2, and 3. Since the viewer A and the viewer B have similar preferences (content viewing histories), the videographer 4 (or content captured by the videographer 4) is recommended to the viewer B.

As another example of a CF-like recommendation method, a different content-providing user (or content captured by such a content-providing user) being viewed by another content-viewing user who has viewed content viewed by an arbitrary content-providing user can be recommended. For example, in the case in which a viewer A and a viewer B both have viewed content captured by a videographer 1, a videographer 2 of other content that the viewer A has also viewed is recommended to the viewer B.

Note that the above describes matching processes in accordance with the case in which the viewer, that is, the content-viewing user takes the initiative in selecting the content-providing user or the content. Obviously, even in the case in which the videographer, that is, the content-providing user takes the initiative in selecting the content-viewing user, viewer recommendation information can be presented similarly according to a CBF-like approach or a CF-like approach.

### [5. Processing Sequence Executed by Information Processing Apparatus According to Embodiment of Present Disclosure]

Next, a processing sequence executed by the information processing apparatus according to an embodiment of the present disclosure will be described.

The sequence described below is a sequence in which, in the information processing system 100 illustrated in FIG. 1, the content-viewing user 20 on the content-outputting apparatus 104 side purchases a product on the basis of viewing content provided by the content-providing user 10.

Specifically, the sequence is one in which the user profile of the content-viewing user 20 is applied to select recommended content, the selected recommended content is presented to the content-outputting apparatus 104, and a product related to the presented content is purchased.

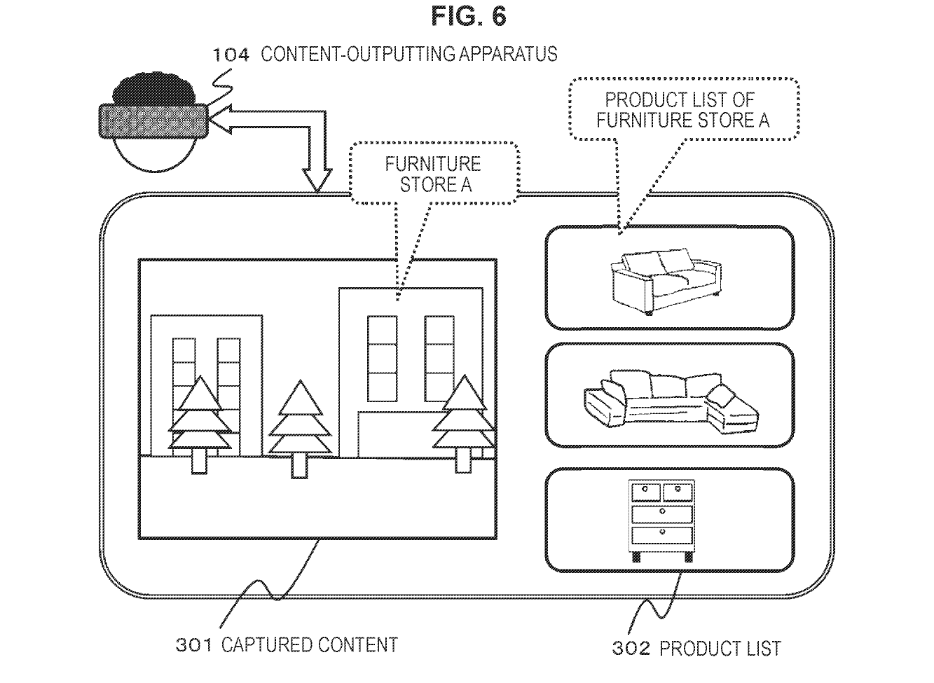

The processing in each step illustrated in the flowchart illustrated in FIG. 6 will be described sequentially.

(Step S101)

First, in step 5101, by a matching process based on the profile of the content-viewing user, recommended content is decided, the recommended content is presented to the content-outputting apparatus, and the user who views the content to be viewed is made to select among the recommended content.

The matching process based on the user profile of the content-viewing user 20 is executed by the information processing server 102 of the information processing system 100 illustrated in FIG. 1, for example. The information processing server 102 acquires the profile of the viewing user of the content-outputting apparatus 104. namely the content-viewing user 20, from the user profile database 112.

Note that when the content-outputting apparatus 104 accesses the information processing server 102, the information processing server 102 receives identification information (ID) of the content-outputting apparatus from the content-outputting apparatus 104 with the access request. The information processing server 102 holds registration information of correspondence data between the content-outputting apparatus and the content-viewing user who uses the apparatus, and on the basis of the registration information, identifies the content-viewing user.

The information processing server 102 acquires the user profile regarding the identified content-viewing user from the user profile database 112. As described earlier with reference to FIG. 4, profile information for each content-viewing user 20 is registered. For example, various user profiles, such as preference information and product purchase history information, are registered.

The information processing server 102, on the basis of the user profile of the content-viewing user 20 stored in the user profile database 112, selects a product for which the content-viewing user 20 has a high purchase intention, a shop that the content-viewing user 20 is likely to have high interest in, or the like. Furthermore, position information about the product or shop is acquired from the position information database 111.

Additionally, a content-providing user 10-x present near the position is specified, and a process of presenting the captured content of the content-providing apparatus 101-x of the content-providing user 10-x as recommended content to the content-viewing user 20 is performed. From the content-providing apparatus 101 that captures content on the content-providing user 10 side, position information is successively output to the information processing server 102, and the information processing server 102 is able to ascertain the position of each of the content-providing users 10-1 to 10-n.

Note that the information processing server 102 may also analyze features of images input from the content-providing apparatus 101 to identify the capturing position, type of product for sale, or the like, and decide recommended content on the basis of the identification result.

Note that the recommended content may be singular or plural. When the recommended content is decided, the information processing server 102 presents the recommended content to the content-outputting apparatus 104 on the content-viewing user 20 side. For example, in the case of presenting a single piece of content, a video of real-time content provided by the selected single content-providing apparatus 101 is displayed. In the case of presenting multiple pieces of content, for example, videos of real-time content provided by the selected multiple content-providing apparatus 101 are displayed side by side. Alternatively, a configuration that displays thumbnail images of the content side by side may be taken.

The content-viewing user 20 selects one piece of content from the content presented on the content-outputting apparatus as the content to connect to.

(Step S102)

Next, in step S102, the information processing server 102 presents recommendation information or advertisement information including a shop, an event, products, or the like at the capturing position of the content provided by the content-providing user 10 to the content-outputting apparatus 104 on the content-viewing user 20 side.

FIG. 6 illustrates an example of display information displayed on the content-outputting apparatus 104 viewed by the content-viewing user 20 as a result of this process. As illustrated in FIG. 6. on the content-outputting apparatus 104, there is displayed captured content 301, which is real-time content captured by the content-providing apparatus 101, and a product list 302, which is a list of products being sold at a shop included in the captured content 301.

The product list 302 includes information that the information processing server 102 has acquired from the position information database 111 on the basis of position information input from the content-providing apparatus 101. As described earlier, the position information database 111 is a database that stores correspondence data between position information, and shop information or product information.

Note that the products displayed as the product list 302 are not limited to products exhibited at a shop included in the captured content 301, and may also be set to include products for sale in a virtual shop, such as an online storefront operated by the shop.

The information processing server 102, on the basis of the position information input from the content-providing apparatus 101, acquires shop information and product information corresponding to the input position information registered in the position information database 111, generates a list thereof, and outputs the list to the content-outputting apparatus 104 being viewed by the content-viewing user 20.

(Step S103)

Next, in step S103, a request, such as entry into the shop where a product on the product list 302 is being sold, or a product search, is issued from the content-viewing user 20 to the content-providing user 10. This process is performed by user input with respect to the content-outputting apparatus 104 on the content-viewing user 20 side.

The user input information is forwarded to the content-providing apparatus 101 through the information processing server 102. Alternatively, a configuration that transmits from the content-outputting apparatus 104 on the content-viewing user 20 side to the content-providing apparatus 101 directly, without going through the information processing server 102, may also be taken.

(Step S104)

Next, in step S104, the content-viewing user 20 confirms an image captured by the content-viewing user 20, selects a product to purchase, and executes a payment process.

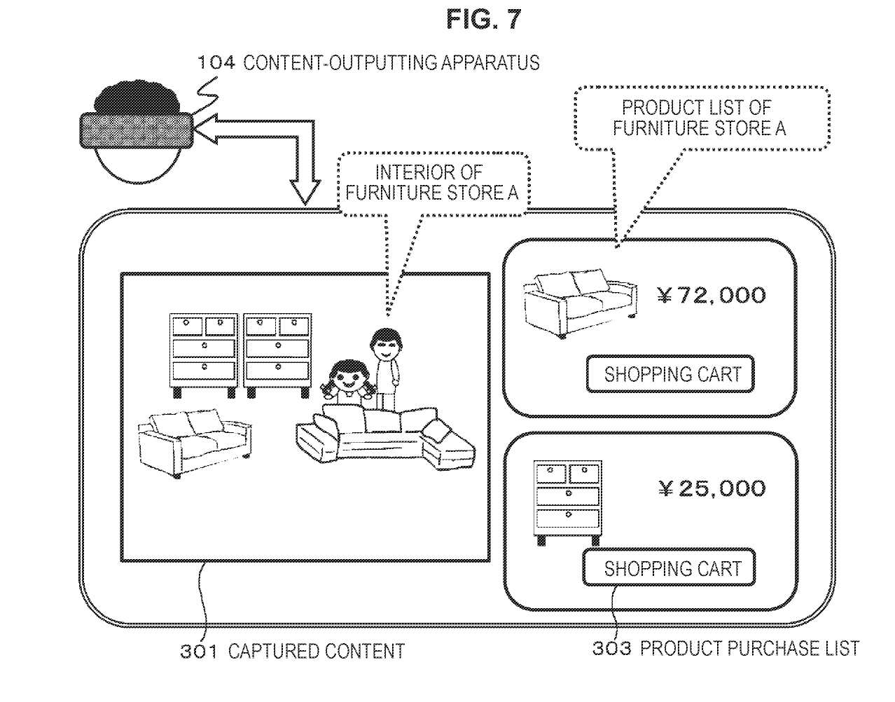

FIG. 7 illustrates an example of display information displayed on the content-outputting apparatus 104 viewed by the content-viewing user 20 in this process. As illustrated in FIG. 7, on the content-outputting apparatus 104, there is displayed captured content 301, which is real-time content captured by the content-providing apparatus 101, and a product purchase list 303 of products being sold at a shop included in the captured content 301. Herein, the product purchase list 303

The product purchase list 303 includes information that the information processing server 102 has acquired from the position information database 111 on the basis of position information input from the content-providing apparatus 101. Note that the products displayed as the product purchase list 303 are not limited to products exhibited at a shop included in the captured content 301, and may also include products for sale in a virtual shop, such as an online storefront operated by the shop.

The content-viewing user 20 selects a desired product to purchase from the product purchase list 303 included in the display information illustrated in FIG. 7, for example, and performs a purchase process and a payment process. Purchase process information and payment information is transmitted to the information processing server 102.

The information processing server 102 communicates with a server operated by the shop selling the product and a payment server, forwards a product purchase request and a payment request by the content-viewing user 20, and causes individual processes to be executed in each server. Note that a configuration that communicates between the content-outputting apparatus 104, and the server operated by the shop and the payment server, and executes the product purchase process and the payment process, without going through the information processing server 102, may also be taken.

(Step S105)

When the product purchase process and the payment process by the content-viewing user 20 in step S104 ends, the product is delivered to the content-viewing user 20 in step S105.

(Step S106)

Finally, in step S106, a process of adding path information of the content-providing user to the profile of the content-viewing user 20 is performed.

This process is executed as a process of the information processing server 102. The information processing server 102 performs a process of adding path information of the content-providing user 10 who entered the shop where the product purchase was performed and assisted with the product purchase to the profile of the content-viewing user 20 who performed the product purchase.

For example, by this process, the shop where the product purchase was performed is registered as a favorite shop of the content-viewing user 20, and is utilized in a later recommended content selection process and the like.

Note that in the embodiment described above, a process using only an image as output information to the content-outputting apparatus 104 is described, but a configuration that outputs an image combined with audio information and the like may also be taken. For example, product guidance information may be output as speech or the like.

### [6. Exemplary Hardware Configuration of Information Processing Apparatus]

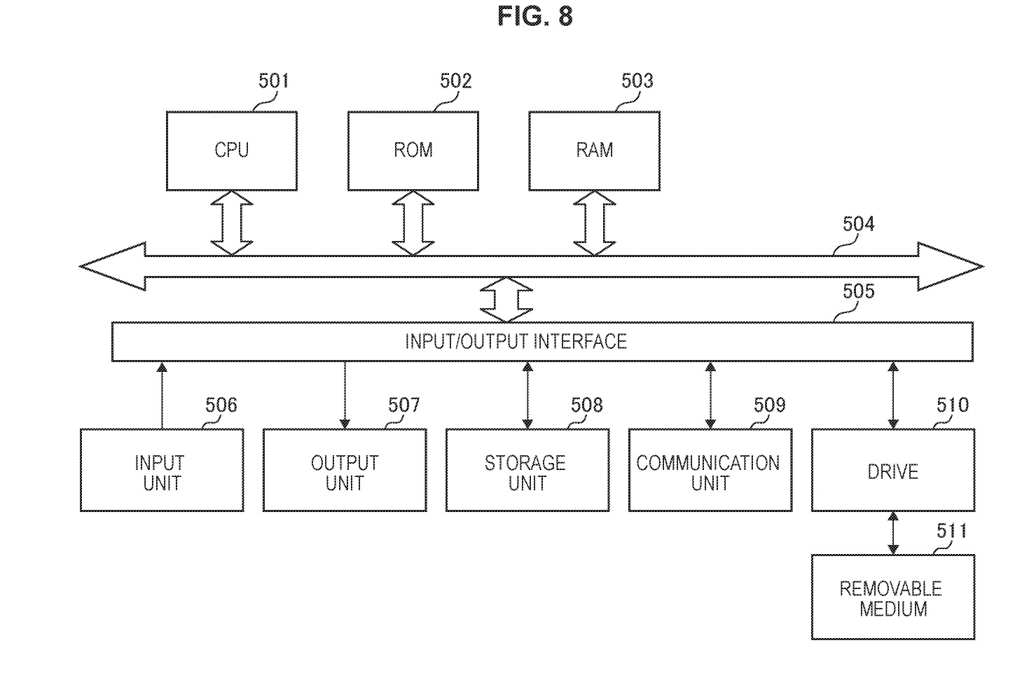

Next, an exemplary hardware configuration of the information processing apparatus will be described with reference to FIG. 8. The hardware described with reference to FIG. 8 is an example of a hardware configuration of the content-providing apparatus 101, an information processing apparatus included in the content-outputting apparatus 104, and additionally an information processing apparatus included in the information processing server 102, which are included in the information processing system described earlier with reference to FIG. 1.

A central processing unit (CPU) 501 functions as a control unit and a data processing unit that executes various processes in accordance with a program stored in read-only memory (ROM) 502 or a storage unit 508. For example, processes following the sequences described in the embodiment described above are executed. Random access memory (RAM) 503 stores programs executed by the CPU 501, data, and the like. The CPU 501, ROM 502, and RAM 503 are interconnected by a bus 504.

The CPU 501 is connected to an input/output interface 505 via the bus 504. Connected to the input/output interface 505 are an input unit 506, which includes various switches, a keyboard, a mouse, a microphone, sensors, and the like, and an output unit 507, which includes a display, speakers, and the like. The CPU 501 executes various processes in response to commands input from the input unit 506, and outputs processing results to the output unit 507, for example. Note that in the case of the content-providing apparatus 101, the input unit 506 includes an imaging unit.

A storage unit 508 connected to the input/output interface 505 includes a hard disk or the like, for example, and stores programs executed by the CPU 501 and various data. A communication unit 509 functions as a transmitting/receiving unit for communication, Bluetooth® (BT) communication, or some other data communication via a network such as the Internet or a local area network, and communicates with external apparatus.

A drive 510 connected to the input/output interface 505 drives a removable medium 511 such as a magnetic disk, an optical disc, a magneto-optical disc, or semiconductor memory such as a memory card, and executes the recording or reading of data.

Hereinafter, a modification will be described in which, while the Body user is describing a product, related information about the product being described is presented to the Ghost user. In this modification, the display of a recommended product is changed in accordance with a change in the product that the Body user is describing. The product that the Body user is describing may be identified by analyzing speech information of the Body user acquired by the audio input unit, for example.

Hereinafter, a modification of a payment process in a case in which the Ghost user is a guardian and the Body user is a ward will be described. One important use case related to content provision is the case in which the Body user is a ward, such as a child, and the Ghost user is a guardian, such as a parent. In this case, a mechanism may be provided whereby, when the Body user makes a purchase, a payment screen for the product that the Body user is attempting to purchase is displayed to the Ghost user, and the Ghost user can pay by proxy. The result of a payment process approved by the Body user is processed in the payment processing system of the shop that the Body user is visiting. Also, in the case of a shop that does not accept payments by a child alone, or in other words, a shop that demands an accompanying guardian when a child purchases a product, a system may be provided in which the shop side is informed that a guardian is watching the movements of the Body user in real-time as a Ghost user, and accompaniment is made unnecessary. Specifically, audio or video of the guardian may be presented to the shop side by audio or video from the terminal of the Body user.

Hereinafter, a modification of content recommendation control based on a path presented to the Ghost user during a JackIn in the past will be described. It is desirable for the referencing of a path presented to the Ghost user to be utilized only in the case in which the Ghost user actually visits a location where the Body user has been, from the perspective of privacy. Alternatively, it is desirable for such referencing to be utilized only when the same Ghost user once again performs a JackIn related to the path again. Based on the above, a configuration may be taken in which path information related to the Ghost user is saved in an encrypted manner, and decrypted only by a terminal related to the Ghost user.

Hereinafter, a modification in which information about the Ghost user is presented to a shop person will be described. When the Ghost user actually visits a shop, it is desirable from the perspective of communication for the shop person to be able to recognize that the Ghost user has come before during a JackIn Consequently, a configuration may be taken in which at least part of the information about the Ghost user is shared from a terminal carried by the Ghost user to a management system on the shop side, for example.

Hereinafter, a modification will be described in which recommendation information based on action information when a JackIn is performed is presented to a terminal other than a head-mounted display, such as a mobile terminal, for example. In the case of presenting some kind of recommendation information to a Ghost user who has performed a JackIn in the past, it is preferable for the Ghost user to be able to ascertain, on a mobile terminal, which Body user the Ghost user was jacked into when a recommendation based on the path of the Body user was made. Consequently, related information from during a JackIn may be added to the recommendation information to the Ghost user. Note that recommendation information may also reflect the preferences of the Body user whom the Ghost user has jacked into in the past. For example, supplementary information may be presented, like “XX, a person you have jacked into before, has given you a like”. By limiting the Body users referenced in this way to users that the Ghost user has jacked into multiple times in the past, more appropriate recommendation information can be presented to the Ghost user. Note that the recommendation information may also not be output if there is no user response after several recommendations.

Hereinafter, a modification related to a notification of a purchase by the Ghost user will be described. Even in the case in which the Body user does not have decision-making authority with respect to a product, having the Body user on site understand whether or not the Ghost user has purchased a product is desirable for a smooth JackIn display experience. Consequently, in response to the purchase of a product by the Ghost user, the Body user may be notified of a product purchase on a terminal of the Body user. For example, when the Ghost user purchases a product, an approval sound may be presented from the terminal of the Body user. Also, when multiple people are jacked into a single Body user, a sound effect notifying that a certain Ghost user has purchased a product may be presented to the other Ghost users.

### [7. Summary of Configuration According to Embodiment of Present Disclosure]

The foregoing thus provides a detailed explanation of embodiments of the present disclosure with reference to specific embodiments. However, it is obvious that persons skilled in the art may make modifications and substitutions to these embodiments without departing from the gist of the present disclosure, in other words, the present disclosure has been disclosed by way of example, and should not be interpreted in a limited manner. The gist of the present disclosure should be determined in consideration of the claims.

Additionally, the present technology may also be configured as below.

(1) An information processing apparatus including:

a data processing unit configured to decide recommended content on a basis of a user profile of a content-viewing user, and position information of a content-providing apparatus operated by at least one content-providing user different from the content-viewing user, in which

the data processing unit
transmits the decided recommended content to a content-outputting apparatus of the content-viewing user, and
transmits product information about a product associated with displayed content on the content-outputting apparatus to the content-outputting apparatus.
   (2) The information processing apparatus according to (1), in which

the data processing unit
extracts a product that the content-viewing user is estimated to have an interest in, on a basis of the user profile of the content-viewing user, and
decides content that includes a video of a shop selling the extracted product as the recommended content.
   (3) The information processing apparatus according to (2), in which

the content-providing apparatus generates the recommended content by capturing a real space, and

the data processing unit, on a basis of the position information of the content-providing apparatus, decides the generated recommended content that includes a video of a shop selling a product that a user is estimated to have an interest in as the recommended content.

(4) The information processing apparatus according to (3), in which

the data processing unit decides the recommended content on a basis of stored data in a position information database storing correspondence data between position information of shops and shop information or product information.

(5) The information processing apparatus according to any one of (1) to (4), in which

the data processing unit transmits a product list including images related to products associated with the displayed content to the content-outputting apparatus and causes the content-outputting apparatus to output the product list.

(6) The information processing apparatus according to any one of (1) to (5), in which

the data processing unit transmits a product purchase list including at least one of purchase process information and payment information related to a product associated with the displayed content to the content-outputting apparatus and causes the content-outputting apparatus to output the product purchase list.

(7) The information processing apparatus according to (6), in which

the data processing unit receives a product purchase process request based on the product purchase list by the content-viewing user, and executes data processing attendant on a product purchase process.

(8) The information processing apparatus according to (7), in which

the data processing attendant on the product purchase process is a payment process related to the product associated with the displayed content,

(9) The information processing apparatus according to any one of (1) to (8), in which

in a case in which a product purchase process is confirmed by the content-viewing user, the data processing unit executes a process of adding path information that includes a capturing position of the displayed content to the user profile of the content-viewing user.

(10) The information processing apparatus according to any one of (1) to (9), in which

the data processing unit executes a recommended content selection process applying a filtering process of at least one of content-based filtering (CBF) and collaborative filtering (CO,

(11) The information processing apparatus according to any one of (1) to (10), in which

the recommended content is video content that is captured by a content-providing apparatus, and provided to the content-outputting apparatus in real-time.

(12) An information processing method including:

controlling an information processing apparatus to decide recommended content on a basis of a user profile of a content-viewing user, and position information of a content-providing apparatus operated by at least one content-providing user different from the content-viewing user;

controlling the information processing apparatus to transmit the decided recommended content to a content-outputting apparatus of the content-viewing user; and

controlling the information processing apparatus to transmit product information about a product associated with displayed content on the content-outputting apparatus to the content-outputting apparatus.

(13) A program causing information processing to be executed in an information processing apparatus, the program including:

an instruction of controlling the information processing apparatus to decide recommended content on a basis of a user profile of a content-viewing user, and position information of a content-providing apparatus operated by at least one content-providing user different from the content-viewing user;

an instruction of controlling the information processing apparatus to transmit the decided recommended content to a content-outputting apparatus of the content-viewing user; and

an instruction of controlling the information processing apparatus to transmit product information about a product associated with displayed content on the content-outputting apparatus to the content-outputting apparatus,

(14) An information processing apparatus including:

a data processing unit configured to decide recommended content, on the basis of a user profile of a content-viewing user, in which

the data processing unit transmits the decided recommended content to a content-outputting apparatus on the content-viewing user side, and transmits product information about a product associated with displayed content on the content-outputting apparatus to the content-outputting apparatus.

(15) An information processing method executed in an information processing apparatus,

the information processing apparatus including

a data processing unit configured to decide recommended content, on the basis of a user profile of a content-viewing user,

the method including, by the data processing unit,
transmitting the decided recommended content to a content-outputting apparatus on the content-viewing user side, and
transmitting product information about a product associated with displayed content on the content-outputting apparatus to the content-outputting apparatus.

(16) A program causing information processing to be executed in an information processing apparatus,

the information processing apparatus including

a data processing unit configured to decide recommended content, on the basis of a user profile of a content-viewing user, in which

the program causes the data processing unit to
transmit the decided recommended content to a content-outputting apparatus on the content-viewing user side, and
transmit product information about a product associated with displayed content on the content-outputting apparatus to the content-outputting apparatus.

In addition, it is possible to execute the series of processes described in this specification by hardware, by software, or by a compound configuration of both. In the case of executing processes by software, a program stating a processing sequence may be installed onto memory in a computer built into special-purpose hardware and executed, or alternatively, the program may be installed and executed on a general-purpose computer capable of executed various types of processes. For example, the program may be prerecorded onto a recording medium. Besides installing the program onto a computer from a recording medium, the program may also be received via a network such as a local area network LAN) or the Internet, and installed onto a built-in recording medium such as a hard disk.

Note that the various processes described in the specification not only may be executed in a time series in the order described, but may also be executed in parallel or individually according to the processing performance of the device executing the process, or as needed. Also, in this specification, the term “system” refers to a logical aggregate configuration of multiple devices, and the respective devices of the configuration are not limited to being inside the same housing.

### INDUSTRIAL APPLICABILITY

Thus, as described above, according to the configuration of an embodiment of the present disclosure, there is realized a configuration making it possible to select recommended content based on the profile of a content-viewing user, and also present and purchase products related to the presented content. Specifically, for example, on the basis of a user profile of the content-viewing user, products that the content-viewing user is interested in are estimated, content that includes a video of stores selling the estimated products is decided as recommended content, and the decided recommended content is transmitted to a content-outputting apparatus on the content-viewing user side. Furthermore, a product list and a product purchase list are presented together with the content, enabling the content-viewing user to make product purchases utilizing the product purchase list. According to this configuration, there is realized a configuration making it possible to select recommended content based on the profile of a content-viewing user, and also present and purchase products related to the presented content.

What is claimed is:

1. An information processing apparatus comprising:
a data processing unit configured to decide recommended content on a basis of a user profile of a content-viewing user, and position information of a content-providing apparatus operated by at least one content-providing user different from the content-viewing user, wherein
the data processing unit
transmits the decided recommended content to a content-outputting apparatus of the content-viewing user, and
transmits product information about a product associated with displayed content on the content-outputting apparatus to the content-outputting apparatus.

2. The information processing apparatus according to claim 1, wherein
the data processing unit
extracts a product that the content-viewing user is estimated to have an interest in, on a basis of the user profile of the content-viewing user, and
decides content that includes a video of a shop selling the extracted product as the recommended content.

3. The information processing apparatus according to claim 2, wherein
the content-providing apparatus generates the recommended content by capturing a real space, and
the data processing unit, on a. basis of the position information of the content-providing apparatus, decides the generated recommended content that includes a video of a shop selling a product that a user is estimated to have an interest in as the recommended content.

4. The information processing apparatus according to claim 3, wherein
the data processing unit decides the recommended content on a basis of stored data in a position information database storing correspondence data between position information of shops and shop information or product information.

5. The information processing apparatus according to claim 1, wherein
the data processing unit transmits a product list including images related to products associated with the displayed content to the content-outputting apparatus and causes the content-outputting apparatus to output the product list.

6. The information processing apparatus according to claim 1, wherein
the data processing unit transmits a product purchase list including at least one of purchase process information and payment information related to a product associated with the displayed content to the content-outputting apparatus and causes the content-outputting apparatus to output the product purchase list.

7. The information processing apparatus according to claim 6, wherein
the data processing unit receives a product purchase process request based on the product purchase list by the content-viewing user, and executes data processing attendant on a product purchase process.

8. The information processing apparatus according to claim 7, wherein
the data processing attendant on the product purchase process is a payment process related to the product associated with the displayed content.

9. The information processing apparatus according to claim 1, wherein
in a case in which a product purchase process is confirmed by the content-viewing user, the data processing unit executes a process of adding path information that includes a capturing position of the displayed content to the user profile of the content-viewing user.

10. The information processing apparatus according to claim 1, wherein
the data processing unit executes a recommended content selection process applying a filtering process of at least one of content-based filtering (CBF) and collaborative filtering (CF).

11. The information processing apparatus according to claim 1, wherein
the recommended content is video content that is captured by a content-providing apparatus, and provided to the content-outputting apparatus in real-time.

12. An information processing method comprising:
controlling an information processing apparatus to decide recommended content on a basis of a user profile of a content-viewing user, and position information of a content-providing apparatus operated by at least one content-providing user different from the content-viewing user;
controlling the information processing apparatus to transmit the decided recommended content to a content-outputting apparatus of the content-viewing user; and
controlling the information processing apparatus to transmit product information about a product associated with displayed content on the content-outputting apparatus to the content-outputting apparatus.

13. A program causing information processing to be executed in an information processing apparatus, the program comprising:
an instruction of controlling the information processing apparatus to decide recommended content on a basis of a user profile of a content-viewing user, and position information of a content-providing apparatus operated by at least one content-providing user different from the content-viewing user;
an instruction of controlling the information processing apparatus to transmit the decided recommended content to a content-outputting apparatus of the content-viewing user; and
an instruction of controlling the information processing apparatus to transmit product information about a product associated with displayed content on the content-outputting apparatus to the content-outputting apparatus.
